(19) United States
(12) Patent Application Publication
(10) Pub. No.: US 2018/0217988 A1
(43) Pub. Date: Aug. 2, 2018

(54) ELECTRONIC COMMUNICATION GENERATION USING SEPARATE SYSTEM CONTENT

(71) Applicant: Microsoft Technology Licensing, LLC, Redmond, WA (US)

(72) Inventors: Xiaoyu Chen, Sunnyvale, CA (US); Hsiao-Ping Tseng, Fremont, CA (US); Danfeng Xu, Belmont, CA (US)

(21) Appl. No.: 15/851,086

(22) Filed: Dec. 21, 2017

Related U.S. Application Data
(60) Provisional application No. 62/452,793, filed on Jan. 31, 2017.

(51) Int. Cl. G06F 17/30; H04L 29/08; H04W 4/21; G06Q 50/00

(52) U.S. Cl. CPC G06F 17/30035; H04L 67/22; G06F 17/30058; G06Q 50/01; H04W 4/21

(57) ABSTRACT

A system and method comprises receiving, with a processor, indications of activities by a member of an online social networking system with content items of electronic communications transmitted to the member, selecting a set of content items from one of a first set of content items from an electronic communication system of the online social networking system and a second set of content items from a feed system of the online social networking system based, at least in part, on the activities by the member with the content items of the electronic communications. A network interface device transmits a new electronic communication of the electronic communications based on the one of the first and second sets of content items as selected. The processor receives indications of activities with the content items of the set of content items in the new electronic communication.

### TECHNICAL FIELD

This application claims the benefit of priority to U.S. Provisional Patent Application No. 62/452,793, filed on Jan. 31, 2017, which is incorporated by reference herein in its entirety.

### TECHNICAL FIELD

The subject matter disclosed herein generally relates to social networking system electronic communication generation using content from separate systems of the social networking system.

### BACKGROUND

Online social networking systems conventionally provide an arrangement of content items in a web- or app-based feed. Such content items may be posted to the online social networking system by users of the online social networking system or may be generated by the online social networking system from various sources. Users of the online social networking system may conventionally view and interact with the content items by accessing the feed.

### BRIEF DESCRIPTION OF THE DRAWINGS

Some embodiments are illustrated by way of example and not limitation in the figures of the accompanying drawings.

FIG. 1 is a block diagram illustrating various components or function-modules of a social network system, consistent with some examples.

FIG. 2 is a block diagram of details of portions of a social networking system, including an electronic communication module, and user devices which may couple to the system, in an example embodiment.

FIG. 3 is a depiction of electronic communications, in an example embodiment.

FIG. 4 is a flowchart for providing content items for an electronic communication, in an example embodiment.

FIG. 5 is a block diagram illustrating components of a machine, according to some example embodiments.

### DETAILED DESCRIPTION

Example methods and systems are directed to social networking system electronic communication generation using content from separate systems of the social networking system. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

Online social networking systems may additionally provide messaging services that may allow members and users of the online social networking system to communicate privately or in designated groups. Because such electronic communications may conventionally be configured for personal communications rather than public consumption of content, as with the feed, electronic communication may typically be operated by a system of the online social networking system independent or otherwise distinguishable from systems which provide content on the feed. In particular, the relevant processes to format and provide information for electronic communications may have little to do with the processes to provide content on a feed. Even in circumstances where content items of the social networking system are presented to a user in an electronic communication, such as in a message including a news digest or the like, the manner in which a user interacts with the content items may be different in a message than the manner in which the user interacts with content items in a feed. For instance, an electronic communication may lend itself to a quick scan of a news digest while a feed may lend itself to greater interaction with content items.

However, the establishment of clear differentiation between the feed and electronic communication systems may place limitations on the effectiveness of the inclusion of content items in electronic communications. For instance, while the electronic communication system may select a set of content items for provision to the recipient that is based on factors known to the electronic communication system to be relevant to the recipient, the electronic communication system may not have access or sensitivity to insights gained by the feed system. This may be particularly true given the disparity in the volume of content items provided by each system in a given period of time. A feed system may provide billions of content items to users over relatively short time periods while an electronic communication system may provide orders of magnitude fewer content items over the same time period. As such, the feed system may develop insights into user preferences which the electronic communication system may lack.

An online social networking system has been developed which utilizes separate electronic communication and feed systems to provide sets of content items for electronic communications. The electronic communication system may be separate from the feed system either physically, e.g., by being run with different software as well as different and physically distinct hardware, or logically, e.g., by utilizing different models for selecting content items but otherwise utilizing common hardware, in whole or in part. The online social networking system may identify user interaction with content items and track which of the systems provides sets of content items with which the user has the highest tendency to interact and iteratively update information about a highest effectivity of the two systems in providing sets of content items for a particular user. In any given electronic communication, the online social networking system may select the set of content items from a given system based on which system tends to provide the best user interaction as well as a randomization factor to promote the set of content items from the less-performing system still being presented to the user for information about the effectiveness of the less-performing system.

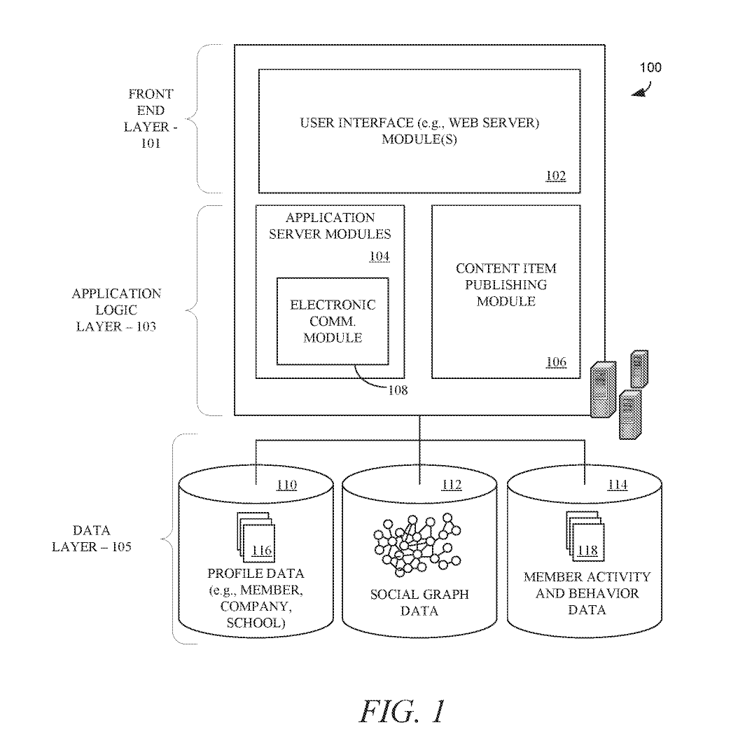

FIG. 1 is a block diagram illustrating various components or functional modules of an online social networking system 100, consistent with some examples. A front end 101 consists of a user interface module (e.g., a web server) 102, which receives requests from various client-computing devices, and communicates appropriate responses to the requesting client devices. For example, the user interface module(s) 102 may receive requests in the form of Hypertext Transport Protocol (HTTP) requests, or other web-based, application programming interface (API) requests. An application logic layer 103 includes various application server modules 104, which, in conjunction with the user interface module(s) 102, may generate various user interfaces (e.g., web pages, applications, etc.) with data retrieved from various data sources in a data layer 105. In some examples, individual application server modules 104 may be used to implement the functionality associated with various services and features of the social network service. For instance, the ability of an organization to establish a presence in the social graph of the social network system 100, including the ability to establish a customized web page on behalf of an organization, and to publish messages or status updates on behalf of an organization, may be services implemented in independent application server modules 104. Similarly, a variety of other applications or services that are made available to members of the social network service may be embodied in their own application server modules 104. Alternatively, various applications may be embodied in a single application server module 104. In some examples, the social network system 100 includes a content item publishing module 106, such as may be utilized to receive content, such as electronic messages, posts, links, images, videos, and the like, and publish the content to the social network in the form of a content item feed.

The application server modules 104 or the social networking system 100 generally may include an electronic communication module 108. As will be disclosed in detail herein, the electronic communication module 108 may generate electronic communications, such as electronic mail, which may be read on conventional email apps or programs, or electronic messages, which may be configured to be viewed within proprietary interfaces of the online social networking system 100. The electronic communication module 108 may further generate a set of content items for inclusion in an electronic communication to a user.

The electronic communication module 108 may be implemented on a separate server or may be part of a server that provides other portions of the social network system 100. Thus, it is to be understood that while the electronic communication module 108 is described as an integral component of an online social networking system, the principles described herein may be applied without the electronic communication module 108 being an integral part of a social networking system, provided the member data of an online social networking system is available to the electronic communication module 108.

As illustrated, the data layer 105 includes, but is not necessarily limited to, several databases 110, 112, 114, such as a database 110 for storing profile data 116, including both member profile data as well as profile data for various organizations. Consistent with some examples, when a person initially registers to become a member of the social network service, the person may be prompted to provide some personal information, such as his or her name, age (e.g., birthdate), gender, interests, contact information, home town, address, the names of the member's spouse and/or family members, educational background (e.g., schools, majors, matriculation and/or graduation dates, etc.), employment history, skills, professional organizations, and so on. This information is stored, for example, in the database 110. Similarly, when a representative of an organization initially registers the organization with the social network service, the representative may be prompted to provide certain information about the organization. This information may be stored, for example, in the database 110, or another database (not shown). With some examples, the profile data may be processed (e.g., in the background or offline) to generate various derived profile data. For example, if a member has provided information about various job titles the member has held with the same or different companies, and for how long, this information can be used to infer or derive a member profile attribute indicating the member's overall seniority level, or seniority level within a particular company. With some examples, importing or otherwise accessing data from one or more externally hosted data sources may enhance profile data for both members and organizations. For instance, with companies in particular, financial data may be imported from one or more external data sources, and made part of a company's profile.

Once registered, a member may invite other members, or be invited by other members, to connect via the social network service. A “connection” may require a bi-lateral agreement by the members, such that both members acknowledge the establishment of the connection. Similarly, with some examples, a member may elect to “follow” another member. In contrast to establishing a connection, the concept of “following” another member typically is a unilateral operation, and at least with some examples, does not require acknowledgement or approval by the member that is being followed. When one member follows another, the member who is following may receive status updates or other messages published by the member being followed, or relating to various activities undertaken by the member being followed. Similarly, when a member follows an organization, the member becomes eligible to receive messages or status updates published on behalf of the organization. For instance, messages or status updates published on behalf of an organization that a member is following will appear in the member's personalized data feed or content stream. In any case, the various associations and relationships that the members establish with other members, or with other entities and objects, are stored and maintained within the social graph database 112.

Activities by users of the social network system 100 may be logged as activities 118 in the activity and behavior database 114. Such activities 118 may include interactions with content items displayed on the social network. Interactions may include clicking on a link to read an article, commenting on a post to the social network, “liking” or otherwise approving of a post, sharing the post, or any of a variety of mechanisms by which a member may engage with social network content.

The social network service may provide a broad range of other applications and services that allow members the opportunity to share and receive information, often customized to the interests of the member. For example, with some examples, the social network service may include a photo sharing application that allows members to upload and share photos with other members. With some examples, members may be able to self-organize into groups, or interest groups, organized around a subject matter or topic of interest. With some examples, the social network service may host various job listings providing details of job openings with various organizations.

Although not shown, with some examples, the social network system 100 provides an application programming interface (API) module via which third-party applications can access various services and data provided by the social network service. For example, using an API, a third-party application may provide a user interface and logic that enables an authorized representative of an organization to publish messages from a third-party application to various content streams maintained by the social network service. Such third-party applications may be browser-based applications, or may be operating system-specific. In particular, some third-party applications may reside and execute on one or more mobile devices (e.g., phone, or tablet computing devices) having a mobile operating system.

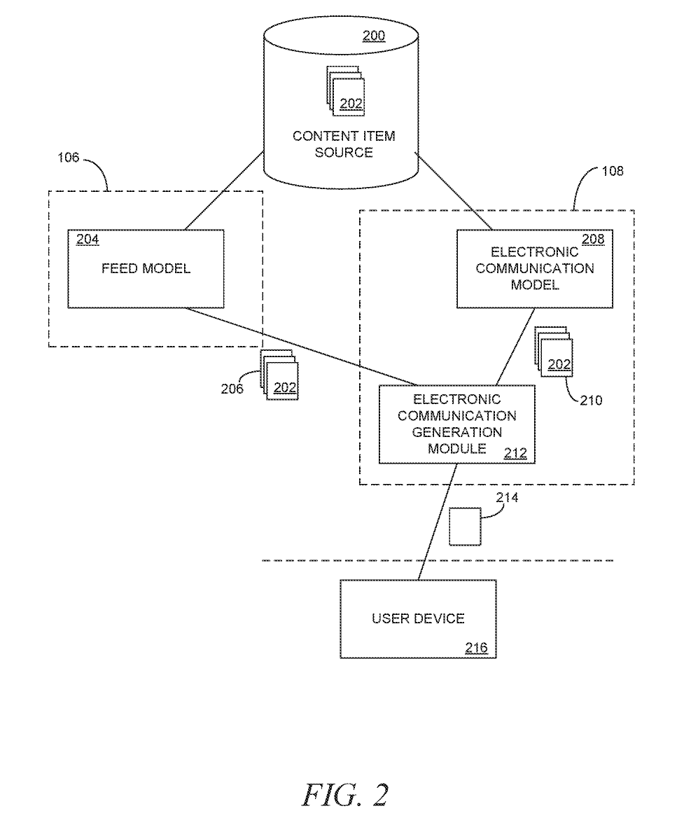

FIG. 2 is a block diagram of details of portions of the social networking system 100, including the content item publishing module 106 and the electronic communication module 108, in an example embodiment. For the purposes of this description, the content item publishing module 106 may be understood to function as a feed system for the provision of the feed, though it is to be recognized and understood that the content item publishing module 106 may include additional capabilities related to the publishing of content items in the online social networking system 100. Further, for the purposes of this description, the electronic communication module 108 may be understood to be an electronic communication system which functions physically or logically separately from the content item publishing module 106 and the feed system generally.

The content item publishing module 106 and the electronic communication module 108 are both coupled to a content item source 200 including multiple content items 202. The content item source 200 may be understood to include multiple individual sources, such as databases organic to the online social networking system 100 or accessible by the online social networking system 100, third-party websites, and/or any source from which a content item 202 may be obtained and displayed to a user of the online social networking system 100.

The content item publishing module 106 includes a feed model 204 configured to utilize data from the data layer 105 to select a set 206 of content items 202 for display on a feed of a member of the online social networking system 100. The electronic communication module 108 includes an electronic communication model 208 configured to select a set 210 of content items 202 for inclusion in an electronic communication of a member. Each model 204, 208 includes one or more mechanisms to select individual content items 202 for inclusion in a respective set 206, 210. Such mechanisms may include various subsystems configured to provide subject matter-specific content items 202, such as those disclosed in U.S. Patent Application Publication No. 2014/0143163, “USER CHARACTERISTICS-BASED SPONSORED JOB POSTINGS”, U.S. Patent Application Publication No. 2014/0143323, “USER CHARACTERISTICS-BASED SPONSORED COMPANY POSTINGS”, and U.S. Patent Application Publication No. 2015/0039406, “INDEPENDENT TARGETED SPONSORED CONTENT MANAGEMENT SYSTEM AND METHOD”, all of which are incorporated by reference herein in their entirety. The models 204, 208 may further include mechanisms for combining content items 202 of various types and from various sources into the respective sets 206, 210 for inclusion in the feed and electronic communications, respectively, as disclosed, for instance, in U.S. patent application Ser. No. 14/633,382, “SOCIAL NETWORK CONTENT ITEM FEDERATION BASED ON ITEM UTILITY VALUE”, incorporated by reference herein in its entirety.

In both cases, the content item module publishing module 106 and the electronic communication module 108 may separately adapt and update their respective models 204, 208 based on various factors, including user engagement and revenue with content items 202 presented in the feed and electronic communications, respectively. Moreover, the models 204, 208 may be administered by different administrators of the online social networking system 100 and, as such, may incorporate various subjective judgments about how the models 204, 208 should favor or disfavor certain types of content items 202. As such, while the individual sets 206, 210 may have some content items 202 in common, may not be intended that the sets 206, 210 have identically the same content items 202 and it may tend to be very atypical that the content items 202 are identical between the sets 206, 210.

The sets 206, 210 of content items 202 are transmitted to an electronic communication generation module 212 of the electronic communication module 108. The electronic communication generation module 212 selects one of the sets 206, 210 and generates an electronic communication 214. The electronic communication 214 includes at least some of the content items 202 of the set 206, 210 selected for transmittal to a user device 216 (which is not necessarily part of the system 100) associated with the member for whom the sets 206, 210 were generated. The electronic communication module 212 causes the electronic communication 214 to be transmitted to the user device 216 by way of the user interface module 102. The electronic communication generation module 212 receives indications of interactions in the form of activities 118, or lack thereof with the content items 202 of the electronic communication 214, and updates the criteria by which the electronic communication generation module 212 selects the sets 206, 210 for future electronic communications 214.

In particular, the electronic communication generation module 212 variously stores or obtains from the activity database 114 activities 118 by the member associated with the user device 216 with the content items 202 of the electronic communication 214. As described above, the as the content items 202 of a given electronic communication 214 correspond to a discrete one of the sets 206, 210, it is clear that the activities 118 from the electronic communication 214 are based on the set 206, 210, produced by one but not both of the feed model 204 and the electronic communication model 208. The electronic communication generation module 212 tracks the activities 118 generated by electronic communications 214 which are based on the sets 206, 210 produced by the models 204, 208 and determines which of the models 204, 208 produces the most and/or highest rate of activities 118.

Thus, in an example, if the electronic communication generation module 212 generates an electronic communication 214 based on the set 206 from the feed model 204, then the resultant activities 118 from the electronic communication 214 are ascribed to the feed model 204. If, for instance, the set 206 included ten (10) content items 202 and three (3) activities 118 were received, (e.g., the member clicked on one link in a content item 202 and “liked” two content items 202), then that set 206 may be deemed to have generated three (3) activities 118 and an activity rate of 3/10 or 0.3.

The electronic communication generation module 212 may store the resultant number of activities 118 and/or the activity rate for each electronic communication 214 as associated with the model 204, 208 that provided the set 206, 210 used to generate the electronic communication 214. The combined activities 118 or activity rates for each model 204, 208 may be updated, e.g., according to a rolling average over a preceding predetermined number electronic communications 214 (e.g., the preceding twenty (20) electronic communications 214), over a predetermined length of time e.g., one (1) month), or according to any desired mechanism. The updating of the activities 118 and/or activity rates for each model may provide an average number of activities 118 or average activity rate, or some other composite value, for each model 204, 208. Thus, by way of an illustrative example, if the feed model 204 has preceding activity rates over the preceding five (5) electronic messages generated based on sets 206 of 0.3, 0.5, 0.2, 0.4, and 0.2, the feed model 204 may have an average activity rate of 0.32. If the electronic communication model 208 has preceding activity rates over the preceding five (5) electronic messages generated based on sets 210 of 0.5, 0.6, 0.4, 0.6, and 0.5, then the electronic communication model 208 has an average activity rate of 0.52.

The electronic communication generation module 212 may default to using the set 206, 210 from the model 204, 208 having the highest average activity rate or other metric related to the activities 118 received based on the electronic communications 214. Thus, in the above example, the electronic communication generation module 212 may utilize the set 210 from the electronic communication model 208 because the average activity rate of the electronic communication model 208 is greater than the average activity rate of the feed model 204.

In order to prevent the electronic communication generation module 212 from immediately settling in on a single best model 204, 208 and thus potentially not be aware of or capture improvements to the other model 204, 208 over time, the electronic communication generation module 212 may include a randomization component, e.g., by performing randomized A-B testing of the two models 204, 208. Thus, in an example, notwithstanding that the electronic communication model 208 has the higher average activity rate, the set 206 of the feed model 204 may be selected, e.g., ten (10) percent of the time and included in the electronic communication 214 instead of the set 210 of the electronic communication model 208. In that way, if the feed model 204 is periodically updated then updated feed model 204 may eventually produce sets 206 that are included in the electronic communication 214, thereby allowing the effectiveness of the feed model 204 as updated to be assessed.

Additionally or alternatively, rather than selecting the set 206, 210 with the from the model 204, 208 with the highest interaction rate, the electronic communication generation module 212 may introduce randomness in the selection of the sets 206, 210 by making, e.g., a previous interaction rate for a model 204, 208 a weighting factor rather than a determinative basis for making a binary choice. Thus, in the above example where the feed model 204 has an activity rate of 0.32 an the electronic communication model 208 has an activity rate of 0.52, the electronic communication generation module 212 may weight the set 210 as 0.52/(0.52+0.3 =0.619 and the set 206 as 0.32/(0.52+0.32)=0.381. The electronic communication generation module 212 may then utilize a randomization system, e.g., a random number generator, to select one of the sets 206, 210 according to their respective weights, i.e., the set 206 may tend to be selected 38.1 percent of the time and the set 210 may tend to be selected 61.9 percent of the time.

The electronic communication generation module 212 may further arbitrarily or randomly re-weight the sets 206, 210 for other purposes, e.g., to promote the output of one of the models 204, 208 over the other or to otherwise accomplish desired A-B testing. For instance, the electronic communication generation module 212 may multiply an activity rate or weight by a randomization component, e.g., may promote one set 206, 210 by multiplying the activity rate or the weight by a value greater than one (1) or may demote a set 206, 210 by multiplying the activity rate or weight by a value less than one (1).

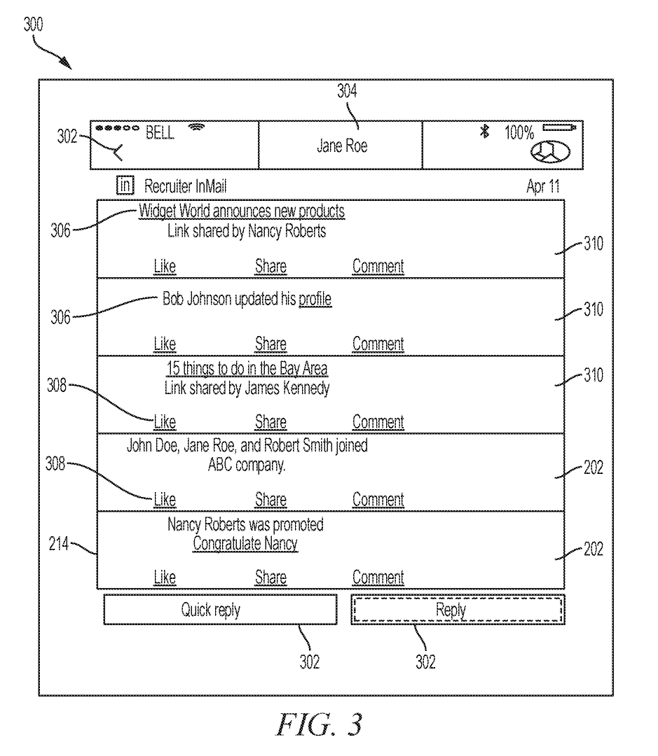

FIG. 3 is a depiction of an electronic communication 214 as displayed on a user interface 300 of a user device 216, in an example embodiment. The electronic communication 214 includes interface buttons 302, e.g., to navigate on the user interface 300 and to reply to the electronic communication 214. The electronic communication 214 also includes an identifier 304 of the member for whom the electronic communication 214 was generated by the electronic communication generation module 212 based on the sets 206, 210 (FIG. 2) received.

The electronic communication 214 further includes the content items 202 of the set 206, 210 selected by the electric communication generation module 212. Each content item 202 includes content 306, e.g., text, graphics, links, etc, that may be read, selected, or otherwise interacted with, as well as activity links 308, e.g., “like”, “share”, “comment”, etc., that allows the member to further interact with the individual content items 202. An activity 118 for the purposes of the electronic communication generation module 212 may be generated when the member selects a content item 202 to view, e.g., by clicking on a content link to access an article or implemented a recommended action (e.g. “Congratulate Nancy”) or perform any of the activity links 308 for a given content item 202. Each selection or activity on a content item 202 may produce an activity 118 to be utilized by the electronic communication generation module 214 as disclosed herein.

As disclosed herein, the electronic communication 214 may be received by the member on any suitable platform provided by the user device 216. For instance, the electronic communication 214 may be displayed on a web browser displaying a webpage served by the online social networking system 100. Alternatively, the electronic communication 214 may be formatted as an email or other format that may be displayed on any of a variety of third-party webpages or applications, such as email programs or webpages. As such, the electronic communication 214 may be defined, at least in part, by a capability of a variety of platforms to receive and display the electronic communication 214 without otherwise being affiliated with the online social networking system 100,

The content items 202 as formatted in the electronic communication 214 may also be formatted for other uses on a user interface 300, e.g., as a feed. Thus, the content items 202 may be ordered according to positions 310 and displayed to the member outside of the context of an electronic communication. Rather, the feed may function as the center of a main webpage or application or “app” for the online social network system 100 and may be displayed on the user interface 300 along with links for other functions related to the online social networking system 100. As such, in contrast to the electronic communication 214, the feed is configured specifically for use in an environment provided and served by the online social networking system 100 itself and which thus exists separately from the provision of electronic communications 214.

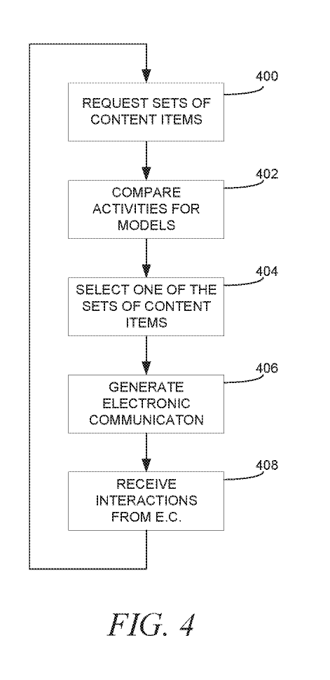

FIG. 4 is a flowchart for providing content items 202 for an electronic communication 214, in an example embodiment. The flowchart may be implemented by the online social networking system 100 or by any suitable system.

At 400, the electronic communication generation module 212 optionally requests sets 206, 210 of content items 202. Alternatively, the content item publishing module 106 and the electronic communication module 108 generate sets 206, 210 automatically, e.g., according to a predetermined schedule.

At 402, upon receipt of both sets 206, 21.0, the electronic communication generation module 212 considers activities 118 generated by interactions by a member who is an intended recipient of a resultant electronic communication 214 with content items 202 of sets 206, 210 previously provided to the member in previous electronic communications 214. In particular, the electronic communication generation module 212 makes a comparison of individual activities 118 and/or the rate at which such activities 118 were generated interactions by the member with the previous electronic communications 214. The activities 118 may be over a predetermined time or over a predetermined number of electronic communications 214 which were sent to the member.

At 404, the electronic communication generation module 212 selects one of the sets 206, 210 for inclusion in an electronic communication 214. The selection may be based, at least in part, on which of the feed model 204 and the electronic communication model 208 have produced the largest number of interactions and/or activities 118 and/or the highest rate of activities 118 in the past. The selection of the one of the sets 206, 210 may be modified or replaced with a randomization component to ensure that a set 206, 210 is, from time to time, included in the electronic communication 214 to assess the effectiveness of the model 204, 208 from which the set 206, 210 was generated.

At 406, the electronic communication generation module 212 generates the electronic communication 214 based on the set 206, 210 as selected at 404 and causes a network interface of the online social networking system 100 to transmit the electronic communication 214 as generated to the user device 216 associated with the member for whom the electronic communication 214 was generated.

At 408, the electronic communication generation module 212 receives indications of interactions by the member with the electronic communication 214, e.g., selection of a link, a “like”, a “comment”, a “share”, etc. In various examples, the electronic communication generation module 212 stores the indications of interactions internally and/or provides the indications of interactions to the activity database 114 to be stored therein as activities 118. Those interactions and/or activities are then utilized in the subsequent generation of electronic communications 214 at operation 402. As such, the electronic communication generation module 208 iteratively updates the population of interactions/activities 118 the electronic communication generation module 208 utilizes in the selection of the one of the sets 206, 210.

### System

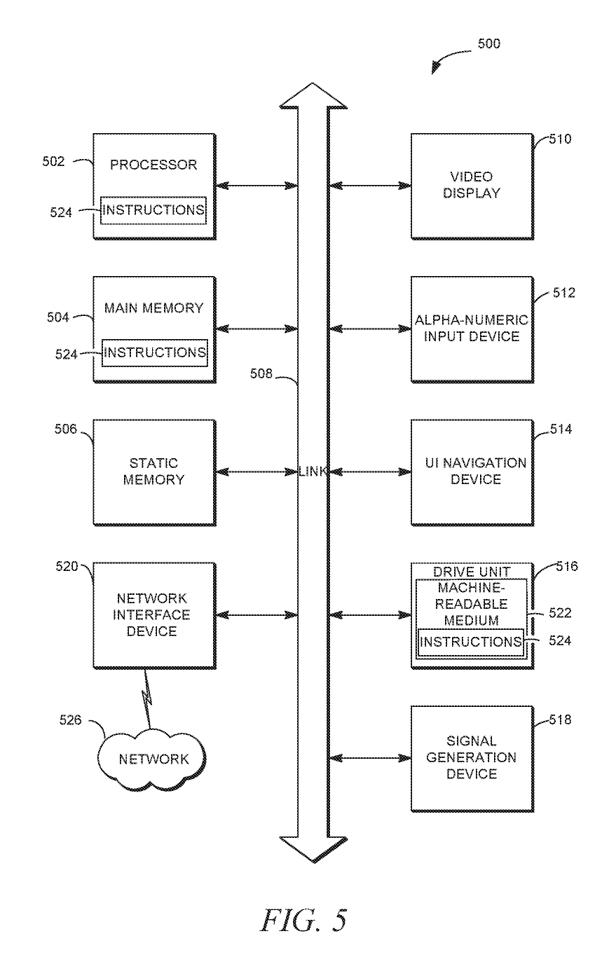

FIG. 5 is a block diagram illustrating components of a machine 500, according to some example embodiments, able to read instructions from a machine-readable medium (e.g., a machine-readable storage medium) and perform any one or more of the methodologies discussed herein. Specifically, the machine 500 may implement the social network system 100 and the features included and described therein. The machine 500 thus describes specific hardware configurations on which the social network system 100 may be implemented and provided to users of the social network system 100.

FIG. 5 shows a diagrammatic representation of the machine 500 in the example form of a computer system and within which instructions 524 (e.g., software) for causing the machine 500 to perform any one or more of the methodologies discussed herein may be executed. In alternative embodiments, the machine 500 operates as a standalone device or may be connected (e.g., networked) to other machines. In a networked deployment, the machine 500 may operate in the capacity of a server machine or a client machine in a server-client network environment, or as a peer machine in a peer-to-peer (or distributed) network environment. The machine 500 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 524, sequentially or otherwise, that specify actions to be taken by that machine. Further, while only a single machine is illustrated, the term “machine” shall also be taken to include a collection of machines that individually or jointly execute the instructions 524 to perform any one or more of the methodologies discussed herein.

The machine 500 includes a processor 502 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 504, and a static memory 506, which are configured to communicate with each other via a bus 508. The machine 500 may further include a graphics display 510 (e.g., a plasma display panel (PDP), a light emitting diode (LED) display, a liquid crystal display (LCD), a projector, or a cathode ray tube (CRT)). The machine 500 may also include an alphanumeric input device 512 (e.g., a keyboard), a cursor control device 514 (e.g., a mouse, a touchpad, a trackball, a joystick, a motion sensor, or other pointing instrument), a storage unit 516, a signal generation device 518 (e.g., a speaker), and a network interface device 520.

The storage unit 516 includes a machine-readable medium 522 on which is stored the instructions 524 (e.g., software) embodying any one or more of the methodologies or functions described herein. The instructions 524 may also reside, completely or at least partially, within the main memory 504, within the processor 502 (e.g., within the processor's cache memory), or both, during execution thereof by the machine 500. Accordingly, the main memory 504 and the processor 502 may be considered as machine-readable media. The instructions 524 may be transmitted or received over a network 526 via the network interface device 520.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 522 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions (e.g., software) for execution by a machine (e.g., machine 500), such that the instructions, when executed by one or more processors of the machine (e.g., processor 502), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner, In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A method, comprising:
receiving, with a processor, indications of activities by a member of an online social networking system with content items of electronic communications transmitted to the member;
selecting, with a processor, a set of content items from one of a first set of content items from an electronic communication system of the online social networking system and a second set of content items from a feed system of the online social networking system based, at least in part, on the activities by the member with the content items of the electronic communications;
causing, with the processor, a network interface device to transmit a new electronic communication of the electronic communications based on the one of the first and second sets of content items as selected;
receiving, with the processor, indications of activities with the content items of the set of content items in the new electronic communication, wherein selecting a subsequent set of content items is further based on the indications of activities with the one of the first and second sets.

2. The method of claim 1, further comprising, prior to causing the network interface to transmit the electronic communication:
obtaining, with the processor, the first set of content items from the electronic communication system; and
obtaining, with the processor, from the feed system, the second set of content items.

3. The method of claim 2, wherein selecting the one of the first and second sets occurs upon receipt of both of the first and second sets.

4. The method of claim 1, wherein selecting the set of content items is based on rates at which the member has had activities with the content items of the first and second sets as transmitted to the member in the electronic communications.

5. The method of claim 4, wherein selecting the set of content items is based on the one of the first and second sets having the highest rate of activities.

6. The method of claim 4, wherein selecting the set of content items is further based on randomization components in combination with the rates.

7. The method of claim 6, wherein the processor multiplies the randomization components with respective ones of the rates and selects the one of the first and second sets based on a highest value combination of randomization components and rates.

8. A computer readable medium including instructions which, when implemented by a processor, cause the processor to perform instructions comprising:
receive indications of activities by a member of an online social networking system with content items of electronic communications transmitted to the member;
select a set of content items from one of a first set of content items from an electronic communication system of the online social networking system and a second set of content items from a feed system of the online social networking system based, at least in part, on the activities by the member with the content items of the electronic communications;
cause a network interface device to transmit a new electronic communication of the electronic communications based on the one of the first and second sets of content items as selected;
receive indications of activities with the content items of the set of content items in the new electronic communication, wherein selecting a subsequent set of content items is further based on the indications of activities with the one of the first and second sets.

9. The computer readable medium of claim 8, further comprising instructions which cause the processor, prior to causing the network interface to transmit the electronic communication to:
obtaining, with the processor, the first set of content items from the electronic communication system; and
obtaining, with the processor, from the feed system, the second set of content items.

10. The computer readable medium of claim 9, wherein selecting the one of the first and second sets occurs upon receipt of both of the first and second sets.

11. The computer readable medium of claim 8, wherein selecting the set of content items is based on rates at which the member has had activities with the content items of the first and second sets as transmitted to the member in the electronic communications.

12. The computer readable medium of claim 11, wherein selecting the set of content items is based on the one of the first and second sets having the highest rate of activities.

13. The computer readable medium of claim 11, wherein selecting the set of content items is further based on randomization components in combination with the rates.

14. The computer readable medium of claim 13, wherein the instructions cause the processor to multiply the randomization components with respective ones of the rates and selects the one of the first and second sets based on a highest value combination of randomization components and rates.

15. A system, comprising:
a processor; and
a computer readable medium comprising instructions which, when implemented by the processor cause the processor to perform operations comprising:
receive indications of activities by a member of an online social networking system with content items of electronic communications transmitted to the member;
select a set of content items from one of a first set of content items from an electronic communication system of the online social networking system and a second set of content items from a feed system of the online social networking system based, at least in part, on the activities by the member with the content items of the electronic communications;
cause a network interface device to transmit a new electronic communication of the electronic communications based on the one of the first and second sets of content items as selected;
receive indications of activities with the content items of the set of content items in the new electronic communication, wherein selecting a subsequent set of content items is further based on the indications of activities with the one of the first and second sets.

16. The system of claim 15, wherein the computer readable medium further comprises instructions which cause the processor, prior to causing the network interface to transmit the electronic communication to:
obtaining, with the processor, the first set of content items from the electronic communication system; and
obtaining, with the processor, from the feed system, the second set of content items.

17. The system of claim 16, wherein selecting the one of the first and second sets occurs upon receipt of both of the first and second sets.

18. The system of claim 15, wherein selecting the set of content items is based on rates at which the member has had activities with the content items of the first and second sets as transmitted to the member in the electronic communications.

19. The system of claim 18, wherein selecting the set of content items is based on the one of the first and second sets having the highest rate of activities.

20. The system of claim 18, wherein selecting the set of content items is further based on randomization components in combination with the rates.
